SEQUENCE LISTING (1 sequence)

SEQ ID NO: 1 - protein, 269 aa, Bacillus clausii
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

(19) United States
(12) Patent Application Publication
(10) Pub. No.: US 2017/0321157 A1
(43) Pub. Date: Nov. 9, 2017

(54) AUTOMATIC DISHWASHING DETERGENT COMPOSITION

(71) Applicant: The Procter & Gamble Company, Cincinnati, OH (US)

(72) Inventors: Michelle JACKSON, Newcastle upon Tyne (GB); Eva Maria PEREZ-PRAT VINUESA, Newcastle upon Tyne (GB); David John TARBIT, Newcastle upon Tyne (GB); Philip Frank SOUTER, Northumberland (GB); Euan John MAGENNIS, Tyne and Wear (GB); David Edward WILDES, San Francisco, CA (US); Jeffrey W. MUNOS, San Francisco, CA (US); Neelam S. AMIN, Palo Alto, CA (US); David L. MARQUEZ, San Jose, CA (US); Victoria HUANG, Sunnyvale, CA (US); Geetha VEERAMUTHU, Sunnyvale, CA (US); Rei OTSUKA, San Mateo, CA (US)

(21) Appl. No.: 15/585,185

(22) Filed: May 3, 2017

Related U.S. Application Data
(60) Provisional application No. 62/330,926, filed on May 3, 2016.

(51) Int. Cl. C11D 3/386; C11D 17/04; C11D 3/37; C11D 3/00

(52) U.S. Cl. CPC C11D 3/386; C11D 17/045; C11D 17/042; C11D 3/0036; C11D 3/38609; C11D 3/37; C11D 3/38618

(57) ABSTRACT

A phosphate-free automatic dishwashing cleaning composition including an organic complexing agent and a new protease.

### FIELD OF THE INVENTION

The present invention is in the field of detergents. In particular, it relates to a phosphate-free automatic dishwashing detergent composition comprising a new protease. The composition provides improved cleaning under a plurality of conditions versus compositions comprising conventional proteases.

### BACKGROUND OF INVENTION

There is a permanent desire to improve the performance of automatic dishwashing compositions, their environmental profile and to reduce the energy required by the automatic dishwashing process.

Due to environmental concerns phosphate is being replaced by biodegradable complexing agents. These complexing agents are usually strong builders and can negatively affect the stability of enzymes, in particular the strong complexing agents can negatively affect proteases by extracting the central calcium metal ion of the active site of the protease. The proteases can be affected in product and/or in-use. They can be more affected under overbuilt conditions, i.e., when a composition comprises high level of complexing agent and the composition is used in soft water because there will be more free builder to complex with the central calcium metal ion of the active site of the protease.

Automatic dishwashing compositions can be designed to have optimum performance under certain in-use conditions, for example a composition can be designed to have optimum performance in a soft water cycle, however a composition that has optimum performance in soft water might not have optimum performance in a hard water cycle and vice versa.

The object of the present invention is to provide a phosphate-free automatic dishwashing composition that provides better cleaning under a plurality of conditions, including overbuilt conditions.

### SUMMARY OF THE INVENTION

According to the first aspect of the present invention, there is provided a phosphate-free automatic dishwashing cleaning composition. The composition comprises an organic complexing agent and a novel protease. The composition presents improved performance even when soft water is used in the automatic dishwashing process.

According to the second, third and fourth aspects of the invention there are provided methods of automatic dishwashing, involving soft water cycles, long cycles and high temperature cycles, respectively.

The elements of the composition of the invention described in connexion with the first aspect of the invention apply mutatis mutandis to the other aspects of the invention.

### DETAILED DESCRIPTION OF THE INVENTION

The present invention encompasses an automatic dishwashing cleaning composition. The composition is phosphate-free and comprises an organic complexing agent and a protease. The composition presents improved stability and delivers improved cleaning versus cleaning compositions comprising conventional proteases under a plurality of conditions. The invention also encompasses methods of automatic dishwashing with soft water. The invention also encompasses methods of automatic dishwashing, involving long cycles and/or high temperatures.

The protease of the composition of the invention is herein sometimes referred to as “the protease of the invention”. The protease having SEQ ID NO:1 is herein sometimes referred to as “the parent protease”.

The relatedness between two amino acid sequences or between two nucleotide sequences is described by the parameter “sequence identity”.

The term “variant” means a protease comprising a mutation, i.e., a substitution, insertion, and/or deletion, at one or more (e.g., several) positions relative to the parent protease of SEQ ID NO:1. A substitution means replacement of the amino acid occupying a position with a different amino acid; a deletion means removal of the amino acid occupying a position; and an insertion means adding an amino acid adjacent to and immediately following the amino acid occupying a position. The variants of the present invention have at least 80%, preferably at least 85%, more preferably at least 90%, more preferably at least 95% and especially at least 97% identity with the protease of SEQ ID NO: 1.

The term “wild-type” protease means a protease expressed by a naturally occurring microorganism, such as a bacterium, yeast, or filamentous fungus found in nature.

### Enzyme Related Terminology

### Nomenclature for Amino Acid Modifications

In describing enzyme variants herein, the following nomenclature is used for ease of reference: Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

### Protease Amino Acid Numbering

The numbering used in this patent is the BPN′ numbering system which is commonly used in the art. An alternative numbering scheme is numbering the specific amino acid sequence of the protease (GG36) listed as SEQ ID NO:1. For convenience the two different numbering schemes of two variant proteases for use in automatic dishwashing detergent compositions of the invention are compared below in Table 1:

TABLE 1
Protease Mutation numbering

| GG36 numbering (numbering versus | Equivalent BPN' numbering of this |
|---|---|
| SEQ ID NO: 1) | patent |
| N74D + S85R + G116R + S126L + | N76D + S87R + G118R + |
| P127Q + S128A | S128L + P129Q + S130A |
| N74D + S85R + G116R + S126L + | N76D + S87R + G118R + |
| P127Q + S128A + S182D + V238R | S128L + P129Q + S130A + |
| | S188D + V244R |

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of an enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

The term “succinate based compound” and “succinic acid based compound” are used interchangeably herein.

As used herein, articles such as “a” and “an” when used in a claim, are understood to mean one or more of what is claimed or described.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

### The Protease of the Invention

The protease of the present invention has at least 80%, preferably at least 85%, more preferably at least 90%, more preferably at least 95% and especially at least 97% identity with the protease of SEQ ID NO: 1.

The protease of the invention comprises one of the following combinations of two amino acid substitutions selected from the group consisting of:
S3V+S78N; N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+N43R; S24R+Y209W; S24F+S166D; S24R/F+T213A; S24R+H249R; S24R+M222Q; N43R+Y209W; N43R+H249R; N43R+R45T; R45T+H249R; S78G/N+Q206Y/F; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206L+M222Q; Q206L+H249R; Q206Y+T213A; Q206Y+M222Q; M222Q+H249R; Y209W+M222Q; T213A+H249R; Y209W+H249R
   in combination with one or more substitutions at the following positions 76, 87, 118, 128, 129, 130 according to BPN′ numbering.

The protease of the invention comprises one of the following combinations of two amino acid substitutions selected from the group consisting of:

N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+Y209W; S24F+S166D; S24R/F+T213A; S24R+H249R; S24R+M222Q; N43R+H249R; N43R+R45T; R45T+H249R; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206Y+T213A; Q206Y+M222Q; M222Q+H249R; Y209W+M222Q; T213A+H249R; Y209W+H249R
in combination with one or more substitutions at the following positions 76, 87, 118, 128, 129, 130 according to BPN′ numbering.

### Or

The protease of the invention comprises one of the following combinations of two amino acid substitutions selected from the group consisting of:

### S3V+S78N; S24R+N43R; N43R+Y209W; S78G/N+Q206Y/F; Q206L+M222Q; Q206L+H249R

in combination with one or more substitutions at the following positions 76, 87, 118, 128, 129, 130 according to BPN′ numbering.

Preferably, the protease of the invention comprises one of the following combinations of two amino acid substitutions selected from the group consisting of:

S3V+S78N; N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+N43R; S24R+Y209W; S24F+S166D; S24R/F+T213A; S24R+H249R; S24R+M222Q; N43R+Y209W; N43R+H249R; N43R+R45T; R45T+H249R; S78G/N+Q206Y/F; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206L+M222Q; Q206L+H249R; Q206Y+T213A; Q206Y+M222Q; M222Q+H249R; Y209W+M222Q; T213A+H249R; Y209W+H249R
in combination with one or more of the following substitutions N76D; S87R,D; G118R; S128L; P129Q and S130A according to BPN′ numbering.

Preferably, the protease of the invention comprises one of the following combinations of two amino acid substitutions selected from the group consisting of:

N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+Y209W; S24F+S166D; S24R/F+T213A; S24R+H249R; S24R+M222Q; N43R+H249R; N43R+R45T; R45T+H249R; S78G/N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206Y+T213A; Q206Y+M222Q; M222Q+H249R; Y209W+M222Q; T213A+H249R; Y209W+H249R
in combination with one or more of the following substitutions N76D; S87R,D; G118R; S128L; P129Q and S130A according to BPN′ numbering.

### Or

Preferably, the protease of the invention comprises one of the following combinations of two amino acid substitutions selected from the group consisting of:

### S3V+S78N; S24R+N43R; N43R+Y209W; S78G/N+Q206Y/F; Q206L+M222Q; Q206L+H249R

in combination with one or more of the following substitutions N76D; S87R,D; G118R; S128L; P129Q and S130A according to BPN′ numbering.

More preferably the protease comprises one of the following combinations of three amino acid substitutions:

### S3V+S78N+S87R; S3V+S78N+G118R; N18R+S24R+N76D; N18R+N76D+H249R; S24R+N43R+N76D; S24R+N76D+H249R;

### S24F+S78N+G118R; S24F+G118R+S166D; S78N+G118R+S166D;

### T22L+S24F+G118R; T22L+S78N+G118R; T22L+G118R+S166D; T22L+G118R+T213A; S24F+G118R+T213A; S78N+G118R+T213A;

N18R+G20R+N76D; N18R+N43R+N76D; N18R+R45T+N76D; G20R+N76D+H249R; G20R+N43R+N76D; G20R+R45T+N76D; N43R+G118R+Y209W; N43R+R45T+N76D; N43R+N76D+H249R; R45T+N76D+H249R;
N76D+S101A+S188D; N76D+S101A+P210I; N76D+S101A+A232V; N76D+S103A+S188D; N76D+S103A+P210I; N76D+S103A+A232V; N76D+V104I+S188D; N76D+V104I+P210I; N76D+V104I+A232V; N76D+S188D+P210I; N76D+S188D+A232V; N76D+P210I+A232V; N76D+Q206Y+T213A; N76D+S24R+Q206Y; N76D+S24R+M222Q; N76D+Q206Y+M222Q; N76D+T213A+H249R; N76D+T213A+M222Q; N76D+M222Q+H249R; N76D+S78N+Q206L; N76D+S78N+S87R; N76D+S78N+G118R; N76D+S78N+S128L; N76D+S78N+P129Q; N76D+S78N+S130A; N76D+S87R+Q206L; N76D+G118R+Q206L; N76D+S128L+Q206L; N76D+P129Q+Q206L; N76D+S130A+Q206L; S24R+Y209W+G118R; S24R+G118R+M222Q; S24R+G118R+H249R; Y209W+G118R+M222Q; Y209W+G118R+H249R; N76D+Q206L+H249R; S78G+S87R+Q206Y/F; S78G+G118R+Q206Y/F; S78N+G118R+Y209W; S78N+S87D+G118R; S78N+S87D+Q206Y; S87D+Y209W+G118R; S87D+G118R+M222Q; S87D+G118R+H249R: G118R+Q206L+M222Q; G118R+Y209W+M222Q; G118R+M222Q+H249R.

More preferably the protease comprises one of the following combinations of three amino acid substitutions:

### N18R+S24R+N76D; N18R+N76D+H249R; S24R+N76D+H249R;

### S24F+S78N+G118R; S24F+G118R+S166D; S78N+G118R+S166D;

### T22L+S24F+G118R; T22L+S78N+G118R; T22L+G118R+S166D; T22L+G118R+T213A; S24F+G118R+T213A; S78N+G118R+T213A;

### N18R+G20R+N76D; N18R+N43R+N76D; N18R+R45T+N76D; G20R+N76D+H249R; G20R+N43R+N76D; G20R+R45T+N76D; N43R+R45T+N76D; N43R+N76D+H249R; R45T+N76D+H249R;

N76D+S101A+S188D; N76D+S101A+P210I; N76D+S101A+A232V; N76D+S103A+S188D; N76D+S103A+P210I; N76D+S103A+A232V; N76D+V104I+S188D; N76D+V104I+P210I; N76D+V104I+A232V; N76D+S188D+P210I; N76D+S188D+A232V; N76D+P210I+A232V; N76D+Q206Y+T213A; N76D+S24R+Q206Y; N76D+S24R+M222Q; N76D+Q206Y+M222Q; N76D+T213A+H249R; N76D+T213A+M222Q; N76D+M222Q+H249R; N76D+S78N+Q206L; N76D+S78N+S87R; N76D+S78N+G118R; N76D+S78N+S128L; N76D+S78N+P129Q; N76D+S78N+S130A; N76D+S87R+Q206L; N76D+G118R+Q206L; N76D+S128L+Q206L; N76D+P129Q+Q206L; N76D+S130A+Q206L; S24R+Y209W+G118R; S24R+G118R+M222Q; S24R+G118R+H249R; Y209W+G118R+M222Q; Y209W+G118R+H249R; S78N+S87D+G118R; S87D+Y209W+G118R; S87D+G118R+M222Q; S87D+G118R+H249R; G118R+Y209W+M222Q; G118R+M222Q+H249R.

### Or

More preferably the protease comprises one of the following combinations of three amino acid substitutions:

### S3V+S78N+S87R; S3V+S78N+G118R; N43R+G118R+Y209W; N76D+Q206L+H249R; S78G+S87R+Q206Y/F; S78G+G118R+Q206Y/F; S78N+G118R+Y209W; S78N+S87D+Q206Y; G118R+Q206L+M222Q.

Especially preferred proteases comprise one of the following combinations of amino acid substitutions:

### S3V+S78N+S87R+G118R

### S3V+N76D+S78N+G118R+P129Q

### N18R+S24R+N76D+H249R

### N18R+S24R+N76D+S78N+Q206L

### S24F+S78N+G118R+S166D

### S24R+N76D+S78N+Q206L+H249R

### S24R+S78N+G118R+Q206L+M222Q

### S24R+N43R+G118R+Y209W

### T22L+S24F+S78N+G118R+S166D+T213A

### N18R+G20R+N43R+R45T+N76D+H249R

### N76D+S101A+S103A+V104I+S188D+P210I+A232V+Q245R

### G20R+S24R+N43R+N76D

### N76D+S78N+S87R+G118R+S128L+P129Q+S130A

### N76D+S87R+G118R+S128L+P129Q+S130A+Q206L

### N76D+S78N+S87R+G118R+S128L+P129Q+S130A+Q206L

### S24R+N76D+S87R+Q206Y+T213A+M222Q+H249R

### S24R+N76D+S78N+S87D+G118R+Y209W+M222Q+H249R

### N76D+S78N+S87R+G118R+S128L+P129Q+S130A+Y209W

### N76D+S78N+S87D+Q206Y

### S78G+S87R+G118R+Q206Y/F

and preferably the protease has at least 95% identity with the amino acid sequence of SEQ ID NO: 1.

Especially preferred proteases comprise one of the following combinations of amino acid substitutions:

### N18R+S24R+N76D+H249R

### S24F+S78N+G118R+S166D

### T22L+S24F+S78N+G118R+S166D+T213A

### N18R+G20R+N43R+R45T+N76D+H249R

### N76D+S101A+S103A+V104I+S188D+P210I+A232V+Q245R

### G20R+S24R+N43R+N76D

### N76D+S78N+S87R+G118R+S128L+P129Q+S130A

### N76D+S87R+G118R+S128L+P129Q+S130A+Q206L

### N76D+S78N+S87R+G118R+S128L+P129Q+S130A+Q206L

### S24R+N76D+S87R+Q206Y+T213A+M222Q+H249R

### S24R+N76D+S78N+S87D+G118R+Y209W+M222Q+H249R

### N76D+S78N+S87R+G118R+S128L+P129Q+S130A+Y209W

and preferably the protease has at least 95% identity with the amino acid sequence of SEQ ID NO:1.

### Or

Especially preferred proteases comprise one of the following combinations of amino acid substitutions:

### S3V+S78N+S87R+G118R

### S3V+N76D+S78N+G118R+P129Q

### N18R+S24R+N76D+S78N+Q206L

### S24R+N76D+S78N+Q206L+H249R

### S24R+S78N+G118R+Q206L+M222Q

### S24R+N43R+G118R+Y209W

### N76D+S78N+S87D+Q206Y

### S78G+S87R+G118R+Q206Y/F

and preferably the protease has at least 95% identity with the amino acid sequence of SEQ ID NO:1.

Especially preferred proteases for use herein include proteases comprising one of the following combinations of amino acid substitutions:

### N76D+S78N+S87R+G118R+S128L+P129Q+S130A+Q206L

### N76D+S87R+G118R+S128L+P129Q+S130A+Q206L

### N76D+S78N+S87R+G118R+S128L+P129Q+S130A+Y209W

### S24R+N76D+S87R+Q206Y+T213A+M222Q+H249R

### S24R+N76D+S78N+S87D+G118R+Y209W+M222Q+H249R

### S3V+N76D+S78N+S87R+G118R+S128L+P129Q+S130A

### N76D+S78G+S87R+G118R+S128L+P129Q+S130A+Q206F/Y

N76D+S78N+S87D+G118R+S128L+P129Q+S130A+Q206Y and the protease has at least 95% identity with the amino acid sequence of SEQ ID NO:1.

Compositions comprising proteases comprising the following combination of amino acid substitutions:

### S24R+N76D+S78N+S87D+G118R+Y209W+M222Q+H249R; or

### S3V+N76D+S78N+S87R+G118R+S128L+P129Q+5130A

and
having at least 95% identity with the amino acid sequence of SEQ ID NO:1 perform very well in long cycles at high temperature and in soft water.

Compositions comprising proteases comprising the following combination of amino acid substitutions:

### N76D+S78N+S87R+G118R+S128L+P129Q+S130A+Q206L; and

having at least 95%, more preferably at least 97% identity with the amino acid sequence of SEQ ID NO:1 are very versatile because perform very well under most of the conditions found in automatic dishwashing, i.e., low and high temperature and/or long and short cycles.

Preferred levels of protease in the composition of the invention include from about 0.2 to about 2 mg of active protease per grams of the composition.

### Automatic Dishwashing Cleaning Composition

The automatic dishwashing cleaning composition can be in any physical form. It can be a loose powder, a gel or presented in unit dose form. Preferably it is in unit dose form, unit dose forms include pressed tablets and water-soluble packs. The automatic dishwashing cleaning composition of the invention is preferably presented in unit-dose form and it can be in any physical form including solid, liquid and gel form. The composition of the invention is very well suited to be presented in the form of a multi-compartment pack, more in particular a multi-compartment pack comprising compartments with compositions in different physical forms, for example a compartment comprising a composition in solid form and another compartment comprising a composition in liquid form. The composition is preferably enveloped by a water-soluble film such as polyvinyl alcohol. Especially preferred are compositions in unit dose form wrapped in a polyvinyl alcohol film having a thickness of less than 100 μm. The detergent composition of the invention weighs from about 8 to about 25 grams, preferably from about 10 to about 20 grams. This weight range fits comfortably in a dishwasher dispenser. Even though this range amounts to a low amount of detergent, the detergent has been formulated in a way that provides all the benefits mentioned herein above.

The composition is preferably phosphate free. By “phosphate-free” is herein understood that the composition comprises less than 1%, preferably less than 0.1% by weight of the composition of phosphate.

The composition of the invention is phosphate-free and comprises an organic complexing agent and preferably a dispersant polymer. For the purpose of this invention a “complexing agent” is a compound capable of binding polyvalent ions such as calcium, magnesium, lead, copper, zinc, cadmium, mercury, manganese, iron, aluminium and other cationic polyvalent ions to form a water-soluble complex. The complexing agent has a logarithmic stability constant ([log K]) for Ca2+ of at least 3, preferably at least 5 and more preferably at least 6. The stability constant, log K, is measured in a solution of ionic strength of 0.1, at a temperature of 25° C.

The composition of the invention comprises an complexing agent, preferably selected from the group consisting of citric acid its salts and derivatives thereof, methyl-glycine-diacetic acid (MGDA), its salts and derivatives thereof, glutamic-N,N-diacetic acid (GLDA), its salts and derivatives thereof, iminodisuccinic acid (IDS), its salts and derivatives thereof, carboxy methyl inulin, ASDA (L-Aspartic acid N, N-diacetic acid tetrasodium salt), its salts and derivatives thereof its salts and derivatives thereof and mixtures thereof. Especially preferred complexing agent for use herein is selected from the group consisting of MGDA and salts thereof, especially preferred for use herein is the three sodium salt of MGDA. Preferably, the complexing agent is the trisodium salt of MGDA and the dispersant polymer is a sulfonated polymer, more preferably comprising 2-acrylamido-2-methylpropane sulfonic acid monomer. Preferably, the composition of the invention comprises a high level of complexing agent. Preferably the composition comprises at least 10%, more preferably at least 20%, more preferably at least 25% of complexing agent by weight of the composition. The composition preferably comprises less than 70% of complexing agent by weight of the composition.

### Dispersant Polymer

A dispersant polymer can be used in any suitable amount from about 0.1 to about 20%, preferably from 0.2 to about 15%, more preferably from 0.3 to % by weight of the composition.

The dispersant polymer is capable to suspend calcium or calcium carbonate in an automatic dishwashing process.

The dispersant polymer has a calcium binding capacity within the range between 30 to 250 mg of Ca/g of dispersant polymer, preferably between 35 to 200 mg of Ca/g of dispersant polymer, more preferably 40 to 150 mg of Ca/g of dispersant polymer at 25° C. In order to determine if a polymer is a dispersant polymer within the meaning of the invention, the following calcium binding-capacity determination is conducted in accordance with the following instructions:

### Calcium Binding Capacity Test Method

The calcium binding capacity referred to herein is determined via titration using a pH/ion meter, such as the Meettler Toledo SevenMulti™ bench top meter and a PerfectION™ comb Ca combination electrode. To measure the binding capacity a heating and stirring device suitable for beakers or tergotometer pots is set to 25° C., and the ion electrode with meter are calibrated according to the manufacturer's instructions. The standard concentrations for the electrode calibration should bracket the test concentration and should be measured at 25° C. A stock solution of 1000 mg/g of Ca is prepared by adding 3.67 g of CaCl₂-2H₂O into 1 L of deionised water, then dilutions are carried out to prepare three working solutions of 100 mL each, respectively comprising 100 mg/g, 10 mg/g, and 1 mg/g concentrations of Calcium. The 100 mg Ca/g working solution is used as the initial concentration during the titration, which is conducted at 25° C. The ionic strength of each working solution is adjusted by adding 2.5 g/L of NaCl to each. The 100 mL of 100 mg Ca/g working solution is heated and stirred until it reaches 25° C. The initial reading of Calcium ion concentration is conducted at when the solution reaches 25° C. using the ion electrode. Then the test polymer is added incrementally to the calcium working solution (at 0.01 g/L intervals) and measured after 5 minutes of agitation following each incremental addition. The titration is stopped when the solution reaches 1 mg/g of Calcium. The titration procedure is repeated using the remaining two calcium concentration working solutions.

The binding capacity of the test polymer is calculated as the linear slope of the calcium concentrations measured against the grams/L of test polymer that was added.

The dispersant polymer preferably bears a negative net charge when dissolved in an aqueous solution with a pH greater than 6.

The dispersant polymer can bear also sulfonated carboxylic esters or amides, in order to increase the negative charge at lower pH and improve their dispersing properties in hard water. The preferred dispersant polymers are sulfonated/carboxylated polymers, i.e., polymer comprising both sulfonated and carboxylated monomers.

Preferably, the dispersant polymers are sulfonated derivatives of polycarboxylic acids and may comprise two, three, four or more different monomer units. The preferred copolymers contain:

At least one structural unit derived from a carboxylic acid monomer having the general formula (III):

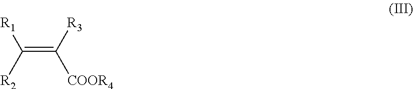

wherein R₁ to R₃ are independently selected from hydrogen, methyl, linear or branched saturated alkyl groups having from 2 to 12 carbon atoms, linear or branched mono or polyunsaturated alkenyl groups having from 2 to 12 carbon atoms, alkyl or alkenyl groups as aforementioned substituted with —NH2 or —OH, or —COOH, or COOR₄, where R₄ is selected from hydrogen, alkali metal, or a linear or branched, saturated or unsaturated alkyl or alkenyl group with 2 to 12 carbons;

Preferred carboxylic acid monomers include one or more of the following: acrylic acid, maleic acid, maleic anhydride, itaconic acid, citraconic acid, 2-phenylacrylic acid, cinnamic acid, crotonic acid, fumaric acid, methacrylic acid, 2-ethylacrylic acid, methylenemalonic acid, or sorbic acid. Acrylic and methacrylic acids being more preferred.

Optionally, one or more structural units derived from at least one nonionic monomer having the general formula (IV):

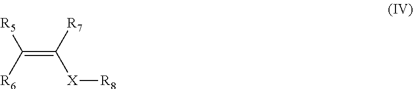

Wherein R₅ to R₇ are independently selected from hydrogen, methyl, phenyl or hydroxyalkyl groups containing 1 to 6 carbon atoms, and can be part of a cyclic structure, X is an optionally present spacer group which is selected from —CH₂—, —COO—, —CONH— or —CONR₈—, and R₈ is selected from linear or branched, saturated alkyl radicals having 1 to 22 carbon atoms or unsaturated, preferably aromatic, radicals having from 6 to 22 carbon atoms.

Preferred non-ionic monomers include one or more of the following: butene, isobutene, pentene, 2-methylpent-1-ene, 3-methylpent-1-ene, 2,4,4-trimethylpent-1-ene, 2,4,4-trimethylpent-2-ene, cyclopentene, methylcyclopentene, 2-methyl-3-methyl-cyclopentene, hexene, 2,3-dimethylhex-1-ene, 2,4-dimethylhex-1-ene, 2, 5-dimethylhex-1-ene, 3,5-dimethylhex-1-ene, 4,4-dimethylhex-1-ene, cyclohexene, methylcyclohexene, cycloheptene, alpha olefins having 10 or more carbon atoms such as, dec-1-ene, dodec-1-ene, hexadec-1-ene, octadec-1-ene and docos-1-ene, preferred aromatic monomers are styrene, alpha methylstyrene, 3-methylstyrene, 4-dodecylstyrene, 2-ethyl-4-bezylstyrene, 4-cyclohexylstyrene, 4-propylstyrol, 1-vinylnaphtalene, 2-vinylnaphtalene; preferred carboxylic ester monomers are methyl (meth)acrylate, ethyl (meth)acrylate, propyl (meth)acrylate, t-butyl (meth)acrylate, pentyl (meth)acrylate, hexyl (meth)acrylate, 2-ethylhexyl (meth)acrylate, octyl (meth)acrylate, lauryl (meth)acrylate, stearyl (meth)acrylate and behenyl (meth)acrylate; preferred amides are N-methyl acrylamide, N-ethyl acrylamide, N-t-butyl acrylamide, N-2-ethylhexyl acrylamide, N-octyl acrylamide, N-lauryl acrylamide, N-stearyl acrylamide, N-behenyl acrylamide.

and at least one structural unit derived from at least one sulfonic acid monomer having the general formula (V) and (VI):

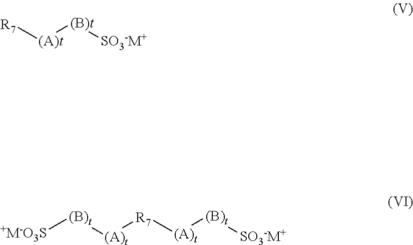

wherein R₇ is a group comprising at least one sp2 bond, A is O, N, P, S, an amido or ester linkage, B is a mono- or polycyclic aromatic group or an aliphatic group, each t is independently 0 or 1, and M+ is a cation. In one aspect, R₇ is a C2 to C6 alkene. In another aspect, R7 is ethene, butene or propene.

Preferred sulfonated monomers include one or more of the following: 1-acrylamido-1-propane sulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propane sulfonic acid, allylsulfonic acid, methallylsulfonic acid, allyloxybenzenesulfonic acid, methallyloxybenzenesulfonic acid, 2-hydroxy-3-(2-propenyloxy) propanesulfonic acid, 2-methyl-2-propen-1-sulfonic acid, styrenesulfonic acid, vinylsulfonic acid, 3-sulfopropyl, 3-sulfo-propylmethacrylate, sulfomethacrylamide, sulfomethylmethacrylamide and mixtures of said acids or their water-soluble salts.

Preferably, the polymer comprises the following levels of monomers: from about 40 to about 90%, preferably from about 60 to about 90% by weight of the polymer of one or more carboxylic acid monomer; from about 5 to about 50%, preferably from about 10 to about 40% by weight of the polymer of one or more sulfonic acid monomer; and optionally from about 1% to about 30%, preferably from about 2 to about 20% by weight of the polymer of one or more non-ionic monomer. An especially preferred polymer comprises about 70% to about 80% by weight of the polymer of at least one carboxylic acid monomer and from about 20% to about 30% by weight of the polymer of at least one sulfonic acid monomer.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

The carboxylic acid is preferably (meth)acrylic acid. The sulfonic acid monomer is preferably 2-acrylamido-2-propanesulfonic acid (AMPS).

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas.

Suitable dispersant polymers include anionic carboxylic polymer of low molecular weight. They can be homopolymers or copolymers with a weight average molecular weight of less than or equal to about 200,000 g/mol, or less than or equal to about 75,000 g/mol, or less than or equal to about 50,000 g/mol, or from about 3,000 to about 50,000 g/mol, preferably from about 5,000 to about 45,000 g/mol. The dispersant polymer may be a low molecular weight homopolymer of polyacrylate, with an average molecular weight of from 1,000 to 20,000, particularly from 2,000 to 10,000, and particularly preferably from 3,000 to 5,000.

The dispersant polymer may be a copolymer of acrylic with methacrylic acid, acrylic and/or methacrylic with maleic acid, and acrylic and/or methacrylic with fumaric acid, with a molecular weight of less than 70,000. Their molecular weight ranges from 2,000 to 80,000 and more preferably from 20,000 to 50,000 and in particular 30,000 to 40,000 g/mol. and a ratio of (meth)acrylate to maleate or fumarate segments of from 30:1 to 1:2.

The dispersant polymer may be a copolymer of acrylamide and acrylate having a molecular weight of from 3,000 to 100,000, alternatively from 4,000 to 20,000, and an acrylamide content of less than 50%, alternatively less than 20%, by weight of the dispersant polymer can also be used. Alternatively, such dispersant polymer may have a molecular weight of from 4,000 to 20,000 and an acrylamide content of from 0% to 15%, by weight of the polymer.

Dispersant polymers suitable herein also include itaconic acid homopolymers and copolymers. Alternatively, the dispersant polymer can be selected from the group consisting of alkoxylated polyalkyleneimines, alkoxylated polycarboxylates, polyethylene glycols, styrene co-polymers, cellulose sulfate esters, carboxylated polysaccharides, amphiphilic graft copolymers and mixtures thereof.

### Bleach

The composition of the invention preferably comprises from about 1 to about 20%, more preferably from about 5 to about 18%, even more preferably from about 8 to about 15% of bleach by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein. Typical organic bleaches are organic peroxyacids, especially dodecanediperoxoic acid, tetradecanediperoxoic acid, and hexadecanediperoxoic acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.01 to 5, preferably from 0.2 to 2% by weight of the composition of bleach activator, preferably TAED.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst.

Bleach catalysts preferred for use herein include manganese triazacyclononane and related complexes; Co, Cu, Mn and Fe bispyridylamine and related complexes; and pentamine acetate cobalt(III) and related complexes.

Preferably the composition of the invention comprises from 0.001 to 0.5, more preferably from 0.002 to 0.05% of bleach catalyst by weight of the composition. Preferably the bleach catalyst is a manganese bleach catalyst.

### Inorganic Builder

The composition of the invention preferably comprises an inorganic builder. Suitable inorganic builders are selected from the group consisting of carbonate, silicate and mixtures thereof. Especially preferred for use herein is sodium carbonate. Preferably the composition of the invention comprises from 5 to 50%, more preferably from 10 to 40% and especially from 15 to 30% of sodium carbonate by weight of the composition.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

### Enzymes

### Other Proteases

Suitable additional proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred additional proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system: V68A, N87S, S99D, S99SD, S99A, S101G, S101M, S103A, V104N/I, G118V, G118R, S128L, P129Q, 5130A, Y167A, R1705, A194P, V2051 and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

### (i) G118V+S128L+P129Q+S130A

### (ii) S101M+G118V+S128L+P129Q+S130A

(iii) N76D+N87R+G118R+S128L+P129Q+S130A+S188D+N248R

### (iv) N76D+N87R+G118R+S128L+P129Q+S130A+S188D+V244R

### (v) N76D+N87R+G118R+S128L+P129Q+S130A

### (vi) V68A+N87S+S101G+V104N

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3®, FN4®, Excellase®, Ultimase® and Purafect OXP® by Genencor International, those sold under the tradename Opticlean® and Optimase® by Solvay Enzymes, those available from Henkel/Kemira, namely BLAP.

Preferred levels of protease in the composition of the invention include from about 0.05 to about 0.5, more preferably from about 0.025 to about 0.35 and especially from about 0.05 to about 0.3 mg of active protease per grams of the composition.

### Amylases

In addition to the protease of the invention the composition of the invention can comprise amylases. A preferred alkaline amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in U.S. Pat. No. 5,856,164 and WO99/23211, WO 96/23873, WO00/60060 and WO 06/002643, especially the variants with one or more substitutions in the following positions versus the AA560 SEQ ID No. 3:
9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*.
(b) variants exhibiting at least 95% identity with the wild-type enzyme from Bacillus sp. 707 (SEQ ID NO:7 in U.S. Pat. No. 6,093,562), especially those comprising one or more of the following mutations M202, M208, 5255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, EVEREST®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE®, EXCELLENZ™ S series, including EXCELLENZ™ S 1000 and EXCELLENZ™ S 2000 and PURASTAR OXAM® (DuPont Industrial Biosciences., Palo Alto, Calif.) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, EXCELLENZ™ S 1000, EXCELLENZ™ 52000 and mixtures thereof.

Preferably, the composition of the invention comprises at least 0.005 mg, preferably from about 0.0025 to about 0.025, more preferably from about 0.05 to about 0.3, especially from about 0.01 to about 0.25 mg of active amylase.

Preferably, the protease and/or amylase of the composition of the invention are in the form of granulates, the granulates comprise more than 29% of sodium sulfate by weight of the granulate and/or the sodium sulfate and the active enzyme (protease and/or amylase) are in a weight ratio of between 3:1 and 100:1 or preferably between 4:1 and 30:1 or more preferably between 5:1 and 20:1.

### Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 5%, more preferably from 0.05 to 3% and especially from 0.5 to 2% of a crystal growth inhibitor by weight of the product, preferably HEDP.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and especially from 0.3 to 3% by weight of the product of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and specially from 0.3 to 3% by weight of the composition of a metal care agent, preferably the glass care agent is a zinc containing material, specially hydrozincite.

The automatic dishwashing composition of the invention preferably has a pH as measured in 1% weight/volume aqueous solution in distilled water at 20° C. of from about 9 to about 12, more preferably from about 10 to less than about 11.5 and especially from about 10.5 to about 11.5. The automatic dishwashing composition of the invention preferably has a reserve alkalinity of from about 10 to about 20, more preferably from about 12 to about 18 at a pH of 9.5 as measured in NaOH with 100 grams of product at 20° C.

A preferred automatic dishwashing composition of the invention comprises:
i) from 2 to 20% by weight of the composition of bleach, preferably sodium percarbonate;
ii) preferably a bleach activator, more preferably TAED;
iii) amylases;
iv) optionally but preferably from 5 to 30% by weight of the composition of an inorganic builder, preferably sodium carbonate;
v) optionally but preferably from 2 to 10% by weight of the composition of a non-ionic surfactant;
vi) optionally but preferably a bleach catalyst, more preferably a manganese bleach catalyst; and
vii) other optional ingredients include: a crystal growth inhibitor, preferably HEDP, and glass care agents.

### EXAMPLES

### Example 1

### Automatic Dishwashing Performance Evaluation of Protease Variants in Automatic Dishwashing Composition.

### I. Preparation of Test Compositions

The following composition was prepared (Composition A):

| Ingredient | Level (% wt) |
|---|---|
| Solid composition | |
| Sodium carbonate, granular | 41.17 |
| Sodium silicate | 0.88 |
| Carboxylated/sulfonated polymer | 7.19 |
| Surfactant - Plurafac ® SLF180 | 0.58 |
| Water | 0.81 |
| Sodium sulphate | 13.64 |
| Methylglycine diacetic acid | 23.34 |
| Bleach activator | 0.29 |
| Sodium percarbonate | 6.01 |
| Perfume, amylase and Processing Aids | Balance |
| Liquid composition | |
| Dipropylene glycol | 20.67 |
| Surfactant - Plurafac ® SLF180 | 59.05 |
| Lutensol TO7 | 14.39 |
| Glycerine | 1.0 |
| Dye | 4.0 |
| Processing Aids | Balance |

The detergent composition above contains no proteases.

### Test A

One dose of detergent composition, comprising 14.69 g of the solid composition and 2.13 g of the liquid composition, was added to each automatic dishwasher at the opening of the dispenser drawer of each cycle.

The compositions detailed in the table below were tested. The protease added is either Ultimase® (outside the scope of the invention) supplied by DuPont, or variants 1, 2, 3 or 4 according to the invention.

Ultimase® and variants 1, 2, 3 and 4 are shown as mgs of active enzyme per detergent dose.

| Example | Composition |
|---|---|
| Example A (nil protease) | Composition A |
| Comparative Example B (Protease | Composition A + 9.1 ppm |
| outside the scope of the invention) | Ultimase ® |
| Example C (protease of the invention) | Composition A + Variant 1 |
| | protease of the |
| | invention 9.1 ppm |
| Example D (protease of the invention) | Composition A + Variant 2 |
| | protease of the |
| | invention 9.1 ppm |
| Example E (protease of the invention) | Composition A + Variant 3 |
| | protease of the |
| | invention 9.1 ppm |
| Example F (protease of the invention) | Composition A + Variant 4 |
| | Protease of the |
| | invention 9.1 ppm |

All enzyme additions are mg active.

Variant 1 is a protease variant of this invention of the wild-type protease B. lentus subtilisin GG36 SEQ ID NO1 with the following substitutions N76D+S87R+G118R+S128L+P129Q+S130A+Q206L and according to the numbering in B. amyloliquefaciens subtilisin BPN′.

Variant 2 is a protease variant of this invention of the wild-type protease B. lentus subtilisin GG36 SEQ ID NO1 with the following substitutions N76D+S78N+S87R+G118R+S128L+P129Q+S130A+Q206L and according to the numbering in B. amyloliquefaciens subtilisin BPN′.

Variant 3 is a protease variant of this invention of the wild-type protease B. lentus subtilisin GG36 SEQ ID NO1 with the following substitutions S24R+N76D+S87R+Q206Y+T213A+M222Q+H249R and according to the numbering in B. amyloliquefaciens subtilisin BPN′.

Variant 4 is a protease variant of this invention of the wild-type protease B. lentus subtilisin GG36 SEQ ID NO1 with the following substitutions S24R+N76D+S78N+S87D+G118R+Y209W+M222Q+H249R and according to the numbering in B. amyloliquefaciens subtilisin BPN′.

### II. Test Stains

Two test stains were used of 6.5 cm×10 cm melamine tiles soiled with Egg Yolk (DM22) and Egg Yolk Milk (DM32), all supplied by the Centre for Testmaterials, Vlaardingen, The Netherlands.

### IV. Test Wash Procedure

### Testing Conditions

### Dishwasher: General Electric 2100

### Machine Cycle: Normal Cycle

Main Wash volume: 3.8 L
Maximum Water temperature: 52.5° C.
Water hardness: 1 gpg (US)
Rinse: 1 rinse

The solid detergent composition was dosed at 3866 ppm and the liquid detergent composition dosed at 553 ppm in a North American automatic dishwashing machine. Two tiles for each stain type were added to each automatic dishwashing machine. Four External replicates were carried out and an average stain removal performance for each stain in each test composition was calculated (8 total replicates for each example detergent). The cleaning performance of Comparative Example A (containing no protease enzyme) was taken as a reference for each test to calculate the delta SRI values. The stains were analysed using image analysis, with results presented below calculated as percentage stain removal, i.e. Stain Removal Index (SRI) for the reference product A, and change in SRI for each of the treatments B (Delta B), C (Delta C), D (Delta D) and so on, versus the reference formulation (in this case Composition A). Tukey's HSD multiple comparison procedure is used in order to control the overall error rate for all pairwise comparisons at 0.05 Stain Removal Index (SRI) is defined as: 0=no removal at all, 100=complete removal.

The performance index was also measured by calculating (the performance of each of Example C, Example D, Example E and Example F minus the performance of comparative example A) divided by (performance of comparative example B minus the performance of comparative example A).

### V. Comparison of Samples

TABLE 1
Stain removal of automatic dishwashing compositions
containing amylase and protease enzymes.

| Stain | Absolute SRI | | Delta Stain Removal vs (A) | | | | | |
|---|---|---|---|---|---|---|---|---|
| Type | (A) | (B) | (B) | (C) | (D) | (E) | (F) | HSD |
| Egg Yolk | 11.4 | 20.3 | 8.9 | 21.8 | 30.1 | 37.7 | 78.4 | 11.7 |
| Egg | 14.6 | 23.5 | 8.9 | 30.5 | 43.4 | 41.8 | 80.5 | 11.4 |
| Yolk/Milk | | | | | | | | |

TABLE 2
Performance Index for Egg Yolk/Milk (8 replicates)

| Example | Performance Index |
|---|---|
| Example A (nil protease) | — |
| Comparative Example B (Protease reference | 1 |
| outside the scope of the invention) | |
| Example C (protease of the invention) | 3.4 |
| Example D (protease of the invention) | 4.9 |
| Example E (protease of the invention) | 4.7 |
| Example F (protease of the invention) | 9.0 |

By comparing the samples washed with the composition of example A (nil protease present) with example B (containing Ultimase®), C, D, E and F (containing variants 1, 2, 3 and 4 respectively), it is apparent that the stain removal performance is improved by the addition of the protease of the invention.

By comparing the samples washed with the composition of example B (containing protease Ultimase® outside the scope of the invention) with examples C, D, E and F (containing protease variants 1, 2, 3 and 4 respectively, of this invention) taking example A as the reference (nil protease enzyme), it is apparent that variants 1, 2, 3 and 4 of the invention are able to achieve significantly higher levels of stain removal than Ultimase®.

### Test B

One dose of detergent composition (Composition A), comprising 14.69 g of the solid composition and 2.13 g of the liquid composition, was added to each automatic dishwasher at the opening of the dispenser drawer of each cycle.

The compositions detailed in the table below were tested. The protease added is either Ultimase® (outside the scope of the invention) supplied by DuPont, or variant 5 of the invention.

Ultimase® and variant 5 are shown as mgs of active enzyme per detergent dose.

| Example | Composition |
|---|---|
| Example A (nil protease) | Composition A |
| Comparative Example B | Composition A + 9.1 ppm Ultimase ® |
| (Protease outside the | |
| scope of the invention) | |
| Example C | Composition A + Variant 5 protease of the |
| (protease of the invention) | invention 9.1 ppm |

All enzyme additions are mg active.

Variant 5 is a protease variant of this invention of the wild-type protease B. lentus subtilisin GG36 SEQ ID NO1 with the following substitutions S3V+N76D+S78N+S87R+G118R+5128L+P129Q+5130A and according to the numbering in B. amyloliquefaciens subtilisin BPN′.

### II. Test Stains

Two test stains were used of 6.5 cm×10 cm melamine tiles soiled with Egg Yolk (DM22) and Egg Yolk Milk (DM32), all supplied by the Centre for Testmaterials, Vlaardingen, The Netherlands.

### IV. Test Wash Procedure

### Testing Conditions

### Dishwasher: Whirlpool Maytag 8959

### Machine Cycle: Heavy Cycle

Main Wash volume: 3.8 L
Maximum Water temperature: 63.5° C.
Water hardness: 1 gpg (US)
Rinse: 1 rinse

The solid detergent composition was dosed at 3866 ppm and the liquid detergent composition dosed at 553 ppm in a North American automatic dishwashing machine. Two tiles for each stain type were added to each automatic dishwashing machine. Four External replicates were carried out and an average stain removal performance for each stain in each test composition was calculated (8 total replicates for each example detergent). The cleaning performance of Comparative Example A (containing no protease enzyme) was taken as a reference for each test to calculate the delta SRI values. The stains were analysed using image analysis, with results presented below calculated as percentage stain removal, i.e. Stain Removal Index (SRI) for the reference product A, and change in SRI for each of the treatments B (Delta B), versus the reference formulation (in this case Composition A). Tukey's HSD multiple comparison procedure is used in order to control the overall error rate for all pairwise comparisons at 0.05 Stain Removal Index (SRI) is defined as: 0=no removal at all, 100=complete removal.

### V. Comparison of Samples

TABLE 3
Stain removal of automatic dishwashing compositions containing
amylase and protease enzymes.

| | Absolute SRI | | Delta Stain Removal vs (A) | | |
|---|---|---|---|---|---|
| Stain Type | (A) | (B) | (B) | (C) | HSD |
| Egg Yolk | 23.8 | 31.0 | 7.2 | 14.1 | 6.2 |
| Egg Yolk/Milk | 12.0 | 23.6 | 11.6 | 16.6 | 5.9 |

By comparing the samples washed with the composition of example A (nil protease present) with example B (containing Ultimase®) and C (containing variant 5), it is apparent that the stain removal performance is improved by the addition of the protease of the invention.

By comparing the samples washed with the composition of example B (containing protease Ultimase® outside the scope of the invention) with example C (containing protease variant 5 of this invention) according to example A as the reference (nil protease enzyme), it is apparent that variant 5 of the invention is able to achieve significantly higher levels of stain removal than Ultimase®.

### Test C

One dose of detergent composition, comprising 14.69 g of the solid composition and 2.13 g of the liquid composition, was added to each automatic dishwasher at the opening of the dispenser drawer of each cycle.

The compositions detailed in the table below were tested. The protease added is either Ultimase® (outside the scope of the invention) supplied by DuPont, or variant 6 of the invention.

Ultimase® and variant 6 are shown as mgs of active enzyme per detergent dose.

| Example | Composition |
|---|---|
| Example A (Protease outsid | Composition A + 9.1 ppm Ultimase ® |
| e the scope of the invention) | |
| Example B | Composition A + Variant 6 protease of the |
| (protease of the invention) | invention 9.1 ppm |

All enzyme additions are mg active.

Variant 6 is a protease variant of this invention of the wild-type protease B. lentus subtilisin GG36 SEQ ID NO1 with the following substitutions N76D+S78N+S87R+G118R+S128L+P129Q+S130A+Y209W and according to the numbering in B. amyloliquefaciens subtilisin BPN′.

### II. Test Stains

Two test stains were used of 6.5 cm×10 cm melamine tiles soiled with Egg Yolk (DM22) and Egg Yolk Milk (DM32), all supplied by the Centre for Testmaterials, Vlaardingen, The Netherlands.

### IV. Test Wash Procedure

### Testing Conditions

### Dishwasher: Whirlpool Maytag 8959

### Machine Cycle: Heavy Cycle

Main Wash volume: 3.8 L
Maximum Water temperature: 63.5° C.
Water hardness: 15 gpg (US)
Rinse: 1 rinse

The solid detergent composition was dosed at 3866 ppm and the liquid detergent composition dosed at 553 ppm in a North American automatic dishwashing machine. Two tiles for each stain type were added to each automatic dishwashing machine. Four External replicates were carried out and an average stain removal performance for each stain in each test composition was calculated (8 total replicates for each example detergent). The cleaning performance of Comparative Example A (containing Ultimase®) was taken as a reference for each test to calculate the delta SRI values. The stains were analysed using image analysis, with results presented below calculated as percentage stain removal, i.e. Stain Removal Index (SRI) for the reference product A, and change in SRI for each of the treatments B (Delta B), versus the reference formulation (in this case Composition A). Tukey's HSD multiple comparison procedure is used in order to control the overall error rate for all pairwise comparisons at 0.05 Stain Removal Index (SRI) is defined as: 0=no removal at all, 100=complete removal.

### V. Comparison of Samples

TABLE 4
Stain removal of automatic dishwashing compositions containing
amylase and protease enzymes.

| | |
|---|---|
| | Delta Stain |
| Absolute SRI | Removal vs (A) |

| Stain Type | (A) | (B) | HSD |
|---|---|---|---|
| Egg Yolk | 70.1 | 19.7 | 13.5 |
| Egg Yolk/Milk | 40.0 | 52.5 | 14.9 |

By comparing the samples washed with the composition of example A (containing protease Ultimase® outside the scope of the invention) with example B (containing protease variant 6 of this invention), it is apparent that variant 6 of the invention is able to achieve significantly higher levels of stain removal than Ultimase®.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A phosphate-free automatic dishwashing cleaning composition comprising an organic complexing agent and a protease wherein the protease is a variant of a parent protease having the amino acid sequence of SEQ ID NO:1 having at least 80% identity with the amino acid sequence of SEQ ID NO:1 and comprising one of the following combinations of two amino acid substitutions selected from the group consisting of:
S3V+S78N; N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+N43R; S24R+Y209W; S24F+S166D; S24R/F+T213A; S24R+H249R; S24R+M222Q; N43R+Y209W; N43R+H249R; N43R+R45T; R45T+H249R; S78G/N+Q206Y/F; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206L+M222Q; Q206L+H249R; Q206Y+T213A; Q206Y+M222Q; M222Q+H249R; Y209W+M222Q; T213A+H249R; Y209W+H249R
in combination with one or more substitutions at the following positions 76, 87, 118, 128, 129, 130 according to BPN′ numbering.

2. A composition according to claim 1 wherein the protease comprises one of the following combinations of two amino acid substitutions selected from the group consisting of:
N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+Y209W; S24F+S166D; S24R/F+T213A; S24R+H249R; S24R+M222Q; N43R+H249R; N43R+R45T; R45T+H249R; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206Y+T213A; Q206Y+M222Q; M222Q+H249R; Y209W+M222Q; T213A+H249R; Y209W+H249R.

3. A composition according to claim 1 wherein the protease comprises one of the following combinations of two amino acid substitutions selected from the group consisting of:
S3V+S78N; S24R+N43R; N43R+Y209W; S78G/N+Q206Y/F; Q206L+M222Q; Q206L+H249R.

4. A composition according to claim 1 wherein the protease comprises one of the following combinations of two amino acid substitutions selected from the group consisting of:
S3V+S78N; N18R+G20R; N18R+S24R; N18R+N43R; N18R+R45T; N18R+H249R; G20R+N43R; G20R+R45T; G20R+H249R; T22L+S24F; T22L+S78N; T22L+S166D; T22L+T213A; S24R/F+S78N; S24R+N43R; S24R+Y209W; S24F+S166D; S24R/F+T213A; S24R+H249R; S24R+M222Q; N43R+Y209W; N43R+H249R; N43R+R45T; R45T+H249R; S78G/N+Q206Y/F; S78N+S166D; S78N+Q206L; S78N+Y209W; S78N+T213A; S101A+S188D; S101A+P210I; S101A+A232V; S103A+S188D; S103A+P210I; S103A+A232V; V104I+S188D; V104I+P210I; V104I+A232V; S166D+T213A; S188D+P210I; S188D+A232V; S188D+Q245R; P210I+A232V; A232V+Q245R; Q206L+M222Q; Q206L+H249R; Q206Y+T213A; Q206Y+M222Q; M222Q+H249R; Y209W+M222Q; T213A+H249R; Y209W+H249R
in combination with one or more of the following substitutions N76D; S87R,D; G118R; S128L; P129Q and S130A according to BPN′ numbering.

5. A composition according to claim 1 wherein the protease comprises one of the following combinations of three amino acid substitutions:
S3V+S78N+S87R; S3V+S78N+G118R; N18R+S24R+N76D; N18R+N76D+H249R; S24R+N43R+N76D; S24R+N76D+H249R;
S24F+S78N+G118R; S24F+G118R+S166D; S78N+G118R+S166D;
T22L+S24F+G118R; T22L+S78N+G118R; T22L+G118R+S166D; T22L+G118R+T213A; S24F+G118R+T213A; S78N+G118R+T213A;
N18R+G20R+N76D; N18R+N43R+N76D; N18R+R45T+N76D; G20R+N76D+H249R; G20R+N43R+N76D; G20R+R45T+N76D; N43R+G118R+Y209W;
N43R+R45T+N76D; N43R+N76D+H249R; R45T+N76D+H249R;
N76D+S101A+S188D; N76D+S101A+P210I; N76D+S101A+A232V; N76D+S103A+S188D; N76D+S103A+P210I; N76D+S103A+A232V; N76D+V104I+S188D; N76D+V104I+P210I; N76D+V104I+A232V; N76D+S188D+P210I; N76D+S188D+A232V; N76D+P210I+A232V; N76D+Q206Y+T213A; N76D+S24R+Q206Y; N76D+S24R+M222Q; N76D+Q206Y+M222Q; N76D+T213A+H249R; N76D+T213A+M222Q; N76D+M222Q+H249R; N76D+S78N+Q206L; N76D+S78N+S87R; N76D+S78N+G118R; N76D+S78N+S128L; N76D+S78N+P129Q; N76D+S78N+S130A; N76D+S87R+Q206L; N76D+G118R+Q206L; N76D+S128L+Q206L; N76D+P129Q+Q206L; N76D+S130A+Q206L; S24R+Y209W+G118R; S24R+G118R+M222Q; S24R+G118R+H249R; Y209W+G118R+M222Q; Y209W+G118R+H249R; N76D+Q206L+H249R; S78G+S87R+Q206Y/F; S78G+G118R+Q206Y/F; S78N+G118R+Y209W; S78N+S87D+G118R; S78N+S87D+Q206Y; S87D+Y209W+G118R; S87D+G118R+M222Q; S87D+G118R+H249R: G118R+Q206L+M222Q; G118R+Y209W+M222Q; G118R+M222Q+H249R.

6. A composition according to claim 1 wherein the protease comprises one of the following combinations of amino acid substitutions:
S3V+S78N+S87R+G118R
S3V+N76D+S78N+G118R+P129Q
N18R+S24R+N76D+H249R
N18R+S24R+N76D+S78N+Q206L
S24F+S78N+G118R+S166D
S24R+N76D+S78N+Q206L+H249R
S24R+S78N+G118R+Q206L+M222Q
S24R+N43R+G118R+Y209W
T22L+S24F+S78N+G118R+S166D+T213A
N18R+G20R+N43R+R45T+N76D+H249R
N76D+S101A+S103A+V104I+S188D+P210I+A232V+Q245R
G20R+S24R+N43R+N76D
N76D+S78N+S87R+G118R+S128L+P129Q+S130A
N76D+S87R+G118R+S128L+P129Q+S130A+Q206L
N76D+S78N+S87R+G118R+S128L+P129Q+S130A+Q206L
S24R+N76D+S87R+Q206Y+T213A+M222Q+H249R
S24R+N76D+S78N+S87D+G118R+Y209W+M222Q+H249R
N76D+S78N+S87R+G118R+S128L+P129Q+S130A+Y209W
N76D+S78N+S87D+Q206Y
S78G+S87R+G118R+Q206Y/F.

7. A composition according to claim 1 wherein the protease has at least 95% identity with the amino acid sequence of SEQ ID NO:1.

8. A composition according to claim 1 wherein the protease comprises the following combination of amino acid substitutions:
S24R+N76D+S78N+S87D+G118R+Y209W+M222Q+H249R.

9. A composition according to claim 1 wherein the protease comprises the following combination of amino acid substitutions:
N76D+S87R+G118R+S128L+P129Q+S130A+Q206L.

10. A composition according to claim 1 wherein the protease comprises the following combination of amino acid substitutions:
S3V+N76D+S78N+S87R+G118R+S128L+P129Q+5130A.

11. A composition according to claim 1 wherein the protease comprises the following combination of amino acid substitutions:
N76D+S78G+S87R+G118R+S128L+P129Q+5130A+Q206F/Y.

12. A composition according to claim 1 wherein the protease comprises the following combination of amino acid substitutions:
N76D+S78N+S87D+G118R+S128L+P129Q+5130A+Q206Y.

13. A composition according to claim 1 wherein the complexing agent has a logarithmic stability constant ([log K]) for Ca2+ of at least 3 as measured in a solution of ionic strength of 0.1, at a temperature of 25° C.

14. A composition according to claim 1 wherein the composition comprises at least 10% by weight of the composition of complexing agent.

15. A composition according to claim 1 wherein the complexing agent is selected from the group consisting of methyl glycine diacetic acid, its salts and derivatives thereof, glutamic-N,N-diacetic acid, its salts and derivatives thereof, iminodisuccinic acid, its salts and derivatives thereof, carboxy methyl inulin, its salts and derivatives thereof, and mixtures thereof.

16. A composition according to claim 1 comprising:
a) from about 0.2 to about 2 mg of protease per gram of the composition;
b) from about 0.025 to about 0.3 mg of amylase per gram of the composition;
c) from about 5 to about 20% by weight of the composition of bleach;
d) from about 10 to about 40% by weight of the composition of a complexing agent; and
e) from about 1 to about 10% by weight of the composition of a dispersant polymer.

17. A composition according to claim 1 wherein the composition is in unit dose form, preferably in the form of a water-soluble pack.

18. A method of automatic dishwashing comprising the following steps:
a) providing soiled dishware;
b) placing the soiled dishware into an automatic dishwasher;
c) providing an automatic dishwashing cleaning composition according to claim 1; and
d) subjecting the dishware to a soft water wash cycle wherein the water hardness is less than 5 gpg.

19. A method of automatic dishwashing comprising the following steps:
a) providing soiled dishware;
b) placing the dishware into an automatic dishwasher;
c) providing an automatic dishwashing cleaning composition according to claim 1; and
d) subjecting the dishware to a wash cycle of equal or more than 30 mins.

20. A method of automatic dishwashing comprising the following steps:
a) providing soiled dishware;
b) placing the soiled dishware into an automatic dishwasher;
c) providing an automatic dishwashing cleaning composition according to claim 1; and
d) subjecting the dishware to a wash cycle at a temperature of 40° C. or above, preferably 50° C. or above.
